(19) United States
(12) Patent Application Publication
(10) Pub. No.: US 2006/0179181 A1
(43) Pub. Date: Aug. 10, 2006

(54) Apparatus and method for controlling direct memory access

(75) Inventor: Shee-Hoon Seong, Suwon-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd.

(21) Appl. No.: 11/341,787

(22) Filed: Jan. 27, 2006

(30) Foreign Application Priority Data
Feb. 4, 2005 (KR) 2005-10769

(51) Int. Cl. G06F 13/28

(52) U.S. Cl. 710/22

(57) ABSTRACT

Provided is an apparatus and method for controlling a Direct Memory Access (DMA). The apparatus includes a plurality of control registers and a control register selection module. The sequentially selects one of the plurality of control registers according to a predetermined change point and a previously stored control register change order list during DMA data transfer to control DMA data transfer according to a value of the selected control register. Thus, a value of a control register is set at an appropriate time point and a load on a main controller due to setting a value of a new control register is reduced.

### PRIORITY

This application claims priority under 35 U.S.C. § 119 to an application entitled “Apparatus and Method for Controlling Direct Memory Access” filed in the Korean Intellectual Property Office on Feb. 4, 2005 and assigned Serial No. 2005-10769, the contents of which are incorporated herein by reference.

### BACKGROUND OF THE INVENTION

1. Field of the Invention

The present invention generally relates to a Direct Memory Access (DMA), and in particular, to an apparatus and method for efficiently controlling a DMA.

2. Description of the Related Art

A DMA is a general input/output (I/O) data transfer method in which data is transferred from a peripheral device to a memory without placing a load on a Central Processing Unit (CPU) using a separate controller. A DMA controller copies data in a specific region to a predetermined region under the control of a main CPU for DMA data transfer. Thus, it is possible not only to reduce a load on the main CPU but also to transfer a large amount of data to a memory at high speeds.

A continuous data transfer process using the DMA will be described with reference to FIGS. 1A and 1B. FIGS. 1A and 1B are timing diagrams of conventional DMA data transfer. FIG. 1A is a timing diagram of DMA data transfer when a transfer period is sufficiently long in continuous DMA data transfer. FIG. 1B is a timing diagram of DMA data transfer when a transfer period is short in continuous DMA data transfer. Referring to FIG. 1A, a1 and a2 represent control register change periods during which a value of a control register of a DMA controller is changed. The control register stores information required for data transfer, such as the length of data to be transferred and a destination address of the data, and the information is changed by a CPU. DMA data transfer is performed according to a value of the control register. b1 and b2 represent data transfer periods during which data is substantially transferred. t1 represents a transfer interval between transfer of consecutive data in continuous data transfer, such as a time interval between the data transfer periods b1 and b2. A main CPU sets a value of the control register during the control register change period a1 or a2 as shown in FIG. 1A prior to DMA data transfer, and a DMA controller transfers data to a corresponding region of a memory according to the set value of the control register during the data transfer period b1 or b2. Thus, when the value of the control register changes during continuous data transfer, smooth data transfer is only possible when the transfer interval t1 is longer than the control register change period a2 required to change the value of the control register as shown in FIG. 1A. However, when the transfer interval t1 is shorter than the control register change period a2 as shown in FIG. 1B, an error may occur during subsequent data transfer (the data transfer period b2). To compensate for the error, a software or hardware load is generated, causing degradation in the performance of the entire system.

The DMA is also used in baseband I/O data transfer of a General Packet Radio Services (GPRS)/Enhanced Data rate for Gsm Evolution (EDGE) mobile communication terminal. FIG. 2 is a block diagram of a GPRS/EDGE mobile communication terminal including a conventional DMA controller. As shown in FIG. 2, the GPRS/EDGE mobile communication terminal includes a main controller 10, a DMA controller 20, a baseband interface buffer 30, and a memory 40. The main controller 10 controls an overall operation of the GPRS/EDGE mobile communication terminal and sets a value of a control register 21 required to store parallel wireless data output from the baseband interface buffer 30 in the memory 40 according to a DMA data transfer method. The main controller 10 corresponds to the main CPU described in the foregoing explanation. The DMA controller 20 transfers data input from the baseband interface buffer 30 to a corresponding region of the memory 40 according to a value of the control register 21.

In the GPRS/EDGE mobile communication terminal, serial data is transferred from the baseband interface buffer 30 to the memory 40 as follows. First, the structure of GPRS/EDGE serial data will be described with reference to FIG. 3. FIG. 3 is a timing diagram of serial data transfer of the GPRS/EDGE mobile communication terminal. A GPRS/EDGE symbol period according to a GPRS/EDGE mobile communication scheme is 3.69 μsec. Once a GPRS/EDGE symbol undergoes analog-to-digital (A/D) conversion, two quantized I and Q data are created. The I data and Q data are serial wireless data and are periodically input to the baseband interface buffer 30 at intervals of a symbol period. A DMA transfer request is generated when the input of serial wireless data into the baseband interface buffer 30 is completed. Referring to FIG. 3, the DMA transfer request is generated at c1 in the case of the I data and is generated at c2 in the case of the Q data. However, if a value of the control register 21 of the DMA controller 20 is changed while the serial wireless data is being received from the baseband interface buffer 30, data errors may be caused. For this reason, the value of the control register 21 can be stably changed during a period between c2 and c3. Thus, the value of the control register 21 of the DMA controller 20 can be changed and used during the period even while serial data is being continuously input.

By using such a method, DMA data transfer for two consecutive data as shown in FIG. 4 is possible. FIG. 4 is a timing diagram of conventional DMA transfer of a GPRS/EDGE mobile communication terminal.

In FIG. 4, a1 and a2 represent control register change periods, b1 and b2 represent actual data transfer periods, and d represents a DMA control program operation period. As shown in FIG. 4, the main controller 10 starts an operation according to a DMA control program at a point where first data transfer is just finished, i.e., b1 is ended. The main controller 10 determines the size of transfer data and a region in which the transfer data is to be stored during DMA data transfer and drives a corresponding task according to the DMA control program. As the last process of the DMA control program, data resulting from the above process is stored in the control register 21 to set the control register 21. However, the main controller 10 should search for the period between c2 and c3 as shown in FIG. 3 before setting the control register 21. To this end, the main controller 10 continuously checks a destination address of currently DMA transferred data and searches for the period between c2 and c3 through even/odd determination. Since such a process causes the main controller 10 to not perform another operation during a maximum of 7.8 μsec, a significant amount of resources are used in terms of the entire mobile communication terminal. Moreover, since the control register 21 is set after the foregoing processes are performed, the control register 21 is substantially set at the end of a2, causing a time difference from a time point where a data transfer period is changed to b2.

When continuous DMA data transfer is desired, a conventional DMA control scheme has problems whereby an accurate control register setting time point may be missed and a main CPU or controller may be occupied for a long period of time to check for conditions for stable control register setting.

### SUMMARY OF THE INVENTION

It is, therefore, an object of the present invention to provide an apparatus and method for controlling a DMA to reduce the time a main controller is occupied due to DMA data transfer.

It is another object of the present invention to provide an apparatus and method for controlling a DMA to provide an accurate control register setting time point during continuous DMA data transfer.

To achieve the above and other objects, there is provided an apparatus for controlling a direct memory access (DMA). The apparatus includes a plurality of control registers and a control register selection module. The module sequentially selects one of the plurality of control registers according to a predetermined change point and a previously stored control register change order list during DMA data transfer to control DMA data transfer according to a value of the selected control register.

To achieve the above and other objects, there is also provided a method for controlling a direct memory access (DMA). The method includes setting a plurality of control registers, sequentially selecting one of the plurality of control registers according to a previously stored control register change order list if predetermined conditions for determining a change point are satisfied, and controlling DMA data transfer according to a value of the selected control register.

### BRIEF DESCRIPTION OF THE DRAWINGS

The above and other objects, features and advantages of the present invention will become more apparent from the following detailed description when taken in conjunction with the accompanying drawings in which:

FIG. 1A is a timing diagram of DMA data transfer when a transfer interval is sufficiently long in continuous DMA data transfer;

FIG. 1B is a timing diagram of DMA data transfer when a transfer interval is short in continuous DMA data transfer;

FIG. 2 is a block diagram of a GPRS/EDGE mobile communication terminal including a conventional DMA controller;

FIG. 3 is a timing diagram of serial data transfer of a GPRS/EDGE mobile communication terminal;

FIG. 4 is a timing diagram of conventional DMA transfer of a GPRS/EDGE mobile communication terminal;

FIG. 5 is a block diagram of a DMA controller according to an embodiment of the present invention;

FIG. 6 is a flowchart illustrating an operation of a main controller according to an embodiment of the present invention;

FIG. 7 is a flowchart illustrating an operation of a control register selection module according to an embodiment of the present invention;

FIG. 8 is a flowchart illustrating an operation of a control register selection controller according to an embodiment of the present invention; and

FIG. 9 is a timing diagram of DMA data transfer according to an embodiment of the present invention.

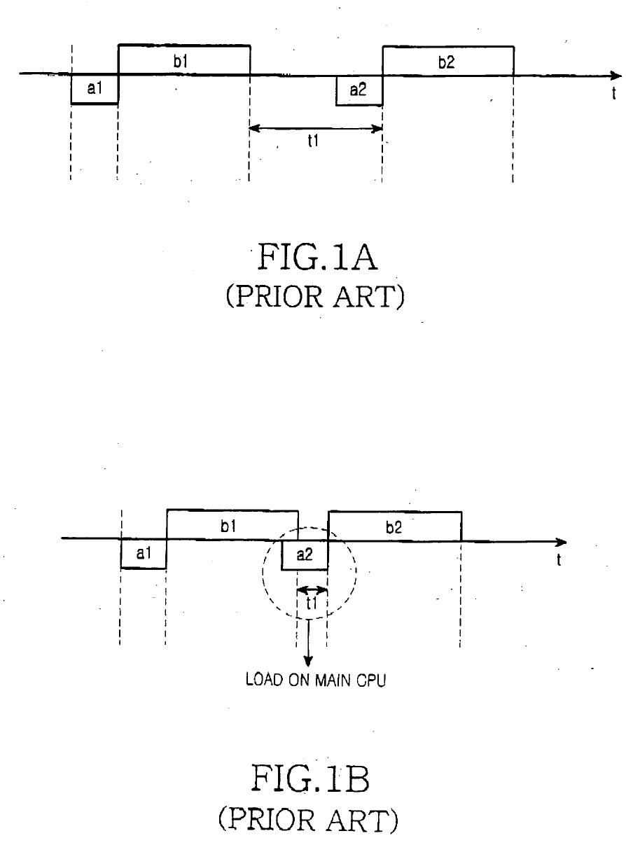

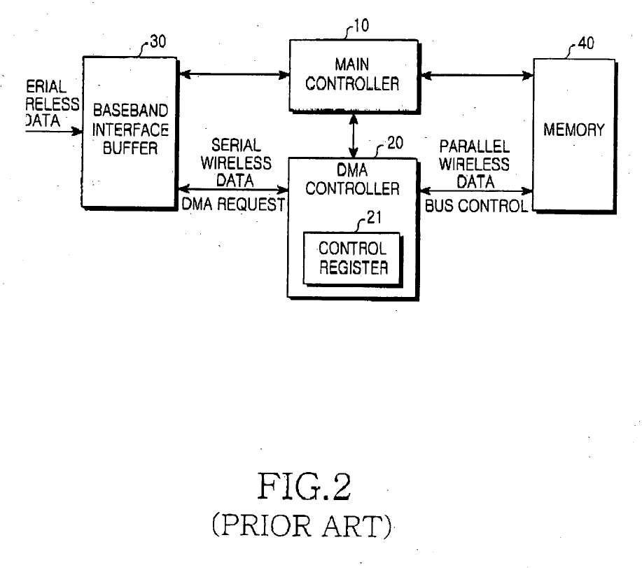

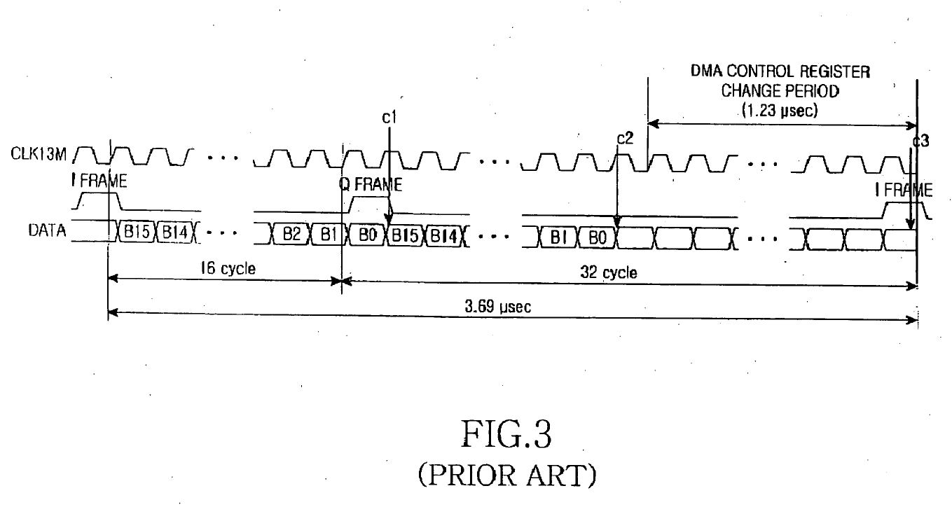

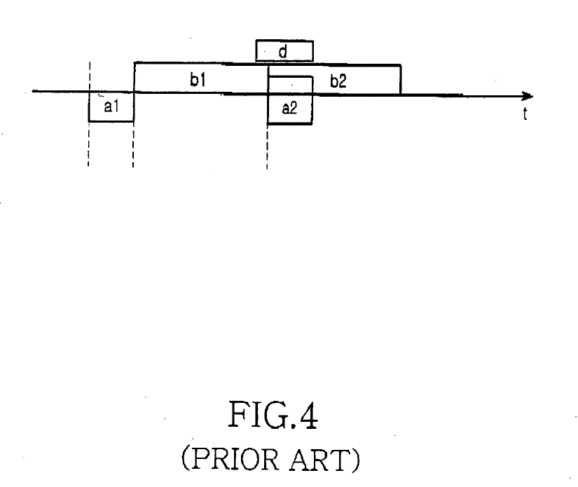

### DETAILED DESCRIPTION OF THE PREFERRED EMBODIMENT

Preferred embodiments of the present invention will now be described in detail with reference to the annexed drawings.

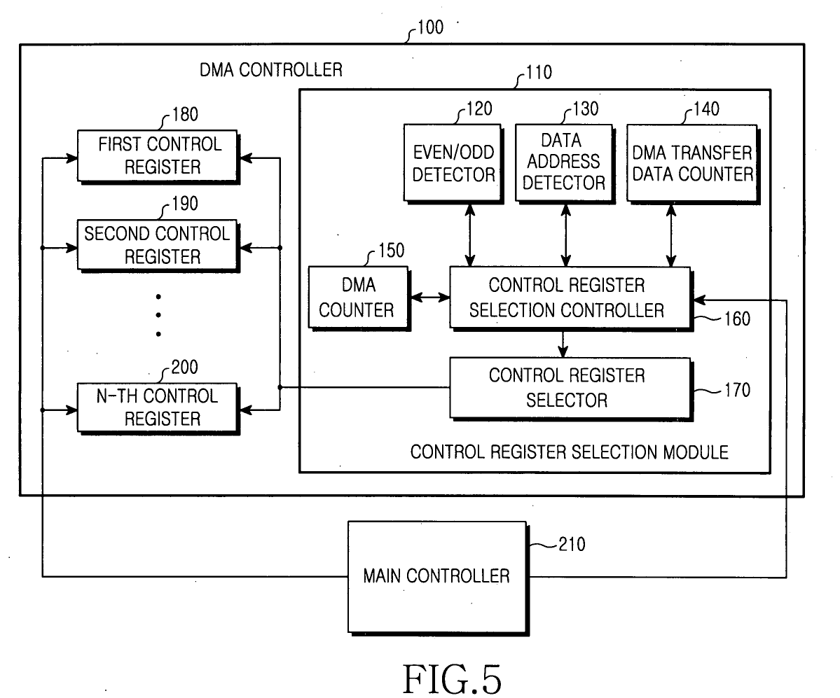

First, a DMA controller will be described with reference to FIG. 5. FIG. 5 is a block diagram of a DMA controller according to an embodiment of the present invention. Referring to FIG. 5, a DMA controller 100 includes a control register selection module 110 and a plurality of control registers including a first control register 180, second control register 190 through n^{th} control register 200. The control register selection module 110 includes an even/odd detector 120, a data address detector 130, a DMA transfer data counter 140, a DMA timer 150, a control register selection controller 160, and a control register selector 170.

A main controller 210 controls an overall operation of a terminal having DMA controller 100, sets the plurality of control registers 180 through 200 relating to DMA data transfer for an arbitrary operation according to an embodiment of the present invention, and sets an operation control value of the DMA controller 100. The plurality of control registers 180 through 200 are set by storing a corresponding value in each of the plurality of control registers. A value of a control register includes the length and number of data to be transferred in a DMA manner and storage start address and destination address information of a memory in which the data is to be stored. The DMA controller 100 performs DMA data transfer according to a value of a control register. The operation control value includes a control register change order list required for continuous DMA data transfer, change point criterion information including conditions for determining a control register change point when a corresponding control register is selected according to the control register change order list, and default control register number information required for the start of DMA data transfer. The default control register number information indicates an initial control register number selected at the start of DMA data transfer.

The change point criterion information required for selection of a new control register may include an even or odd value of a destination address of data that is currently DMA transferred, a specific destination address, a DMA data transfer duration time, the number of transferred DMA data, and a direct change request from the main controller 210. Among the change point criterion information, the even or odd value of a destination address of data that is currently DMA transferred is used to change a control register into another when such a destination address is detected and the detected destination address is an even or odd value. The even or odd value of a destination address is set in the even/odd detector 120. Also from the change point criterion information, the specific destination address is used to change a control register into another when a specific destination address is set, a destination address of data that is currently DMA transferred is detected, and the detected destination address is the same as the specific destination address. The specific destination address is set in the data address detector 130. Further, among the change point criterion information, the DMA transfer duration time is used to change a control register into another when a time interval is set and an interval from the start of DMA transfer to the present time is the same as the set time interval. The DMA transfer duration time is set using the DMA timer 150. Also, among the change point criterion information, the amount of DMA transferred data is used to change a control register into another when an arbitrary data amount is set, data that is currently DMA transferred is counted, and the count value is the same as the set arbitrary data amount. The arbitrary data amount is set in the DMA transfer data counter 140. Finally, of the change point criterion information, the direct change request from the main controller 210 is an interrupt that is irregularly generated by the main controller 210.

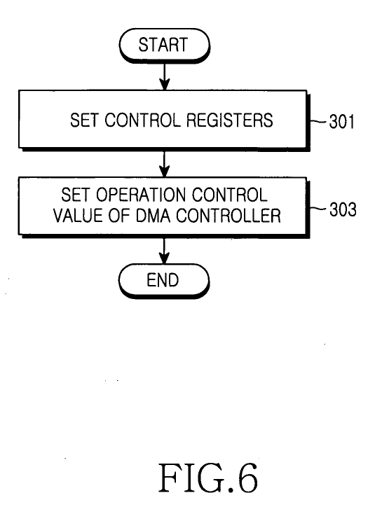

FIG. 6 is a flowchart illustrating an operation of the main controller 210 according to an embodiment of the present invention. Referring to FIG. 6, the main controller 210 sets the plurality of control registers relating to DMA data transfer for an arbitrary operation in step 301 and the process goes to step 303. The main controller 210 sets the plurality of control registers 180 through 200 by storing corresponding values in the plurality of control registers. The main controller 210 sets an operation control value of the DMA controller 100 for an arbitrary operation in step 303 and terminates its operation. The main controller 210 sets the operation control value of the DMA controller 100 by transferring the operation control value to the control register selection module 110.

Referring back to FIG. 5, the control register selection module 110 receives the operation control value, stores the control register change order list included in the operation control value in the control register selection controller 160, and sets the even/odd detector 120, the data address detector 130, the DMA transfer data counter 140, and the DMA timer 150 according to the change point criterion information. The control register selection controller 160 outputs the default control register number information to the control register selector 170.

The even/odd detector 120, the data address detector 130, the DMA transfer data counter 140, and the DMA timer 150 are already set based on the change point criterion information and operate as follows upon the start of DMA data transfer. The even/odd detector 120 detects a destination address of data that is currently DMA transferred during DMA data transfer based on predetermined change point criterion information and outputs a change request signal to the control register selection controller 160 according to an even or odd value of the detected destination address. The data address detector 130 detects an address of data that is currently DMA transferred and outputs the change request signal to the control register selection controller 160 if the detected address is the same as a specific address that is predetermined by the main controller 210. The DMA transfer data counter 140 counts DMA transferred data and outputs the change request signal to the control register selection controller 160 upon DMA transfer of the data of a predetermined amount according to the change point criterion information. The DMA timer 150 outputs the change request signal to the control register selection controller 160 upon completion of a timer period according to setting of the main controller 210.

The control register selection controller 160 outputs a control register change signal to the control register selector 170 upon the start of DMA data transfer and causes the control register selector 170 to select a control register corresponding to the previously stored default control register number information. The control register selection controller 160 outputs next control register number information to the control register selector 170 according to the control register change order list. Once a control register change request is sensed, i.e., the change request signals are input from the even/odd detector 120, the data address detector 130, the DMA transfer data counter 140, and the DMA timer 150, a control register change signal is output to the control register selector 170. Once the change request is directly input from the main controller 210 to the control register selection controller 160, the control register change signal is output to the control register selector 170. Upon reception of the change signal from the control register selection controller 160, the control register selector 170 selects a corresponding control register according to control register number information.

The DMA controller 100 performs DMA data transfer according to a value of the selected control register.

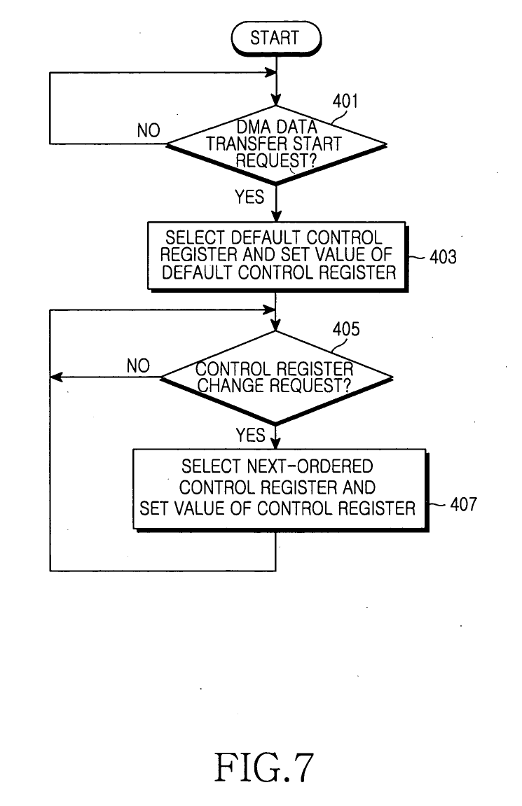

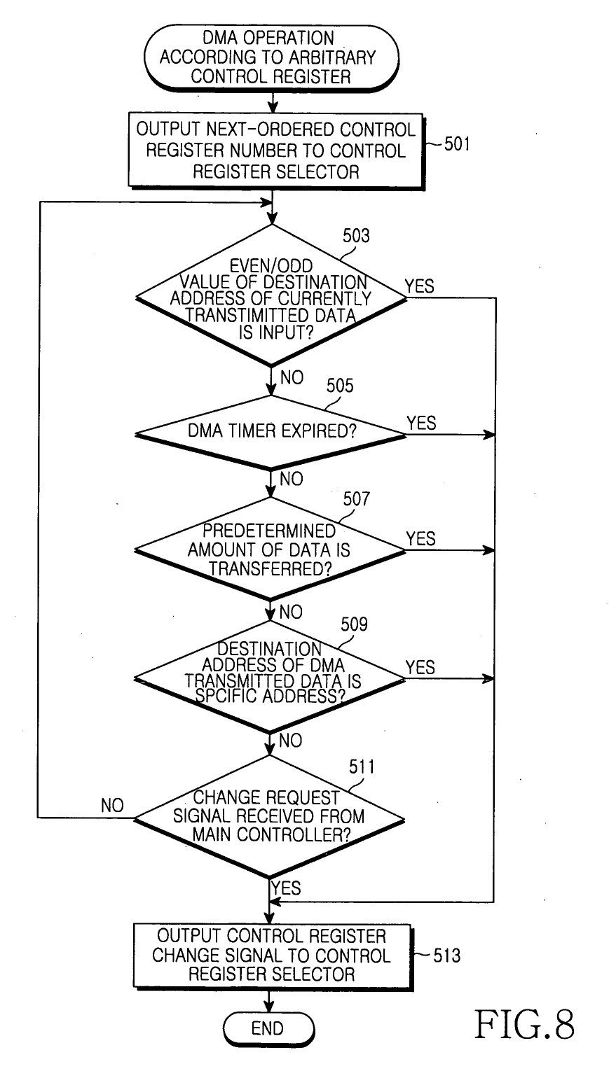

An operation of the DMA controller 100 according to the present invention will be described with reference to FIGS. 7 and 8. FIG. 7 is a flowchart illustrating an operation of the control register selection module 110 according to an embodiment of the present invention. FIG. 8 is a flowchart illustrating an operation of the control register selection controller 160 according to an embodiment of the present invention.

Referring to FIG. 7, once the control register selection module 110 senses a DMA data transfer start request in step 401, the process goes to step 403. The control register selection module 110 selects a default control register that is previously determined by the main controller 210 and sets an initial value of the control register value in step 403 to allow the DMA controller 100 to perform DMA data transfer according to the initial value. Once the control register selection module 110 senses a control register change request in step 405, the process goes to step 407. The control register change request is sensed by the output of change request signals from the even/odd detector 120, the data address detector 130, the DMA transfer data counter 140, the DMA timer 150, and the main controller 210. The control register selection module 100 selects a next-ordered control register among the plurality of control registers according to a previously stored control register change order list upon the reception of the control register change request and sets a value of the selected control register. The DMA controller 100 performs DMA data transfer according to the newly set value. The control register selection module 100 repeats steps 405 through 407 until DMA data transfer is completed.

An operation of the control register selection controller 160 that performs operations relating to steps 405 through 407 will be described with reference to the flowchart of FIG. 8, illustrating an operation of the control register selection controller 160 when the even/odd detector 120, the data address detector 130, the DMA transfer data counter 140, and the DMA timer 150 are set based on the change point criterion information.

Referring to FIG. 8, while the DMA controller 100 performs DMA data transfer according to a value of an arbitrary control register, the control register selection controller 160 outputs a next-ordered control register number to the control register selector 170 according to the predetermined control register change order list in step 501 and the process goes to step 503. The control register selection controller 160 senses an even/odd signal according to a destination address of currently transferred data through the even/odd detector 120 in step 503. The control register selection controller 160 performs step 513 if the even/odd signal is sensed and goes to step 505 if the even/odd signal is not sensed. In step 513, the control register selection controller 160 outputs the control register change signal to the control register selector 170 to cause the control register selector 170 to select a control register corresponding to the control register number received in step 501. The control register selection controller 160 goes back to step 503 to repeat steps 503 through 513.

At step 505, the control register selection controller 160 senses expiration of the DMA timer 150 based on the change request signal input from the DMA timer 150, and goes to step 513 if expiration of the DMA timer 150 is sensed and goes to step 507 if expiration of the DMA timer 150 is not sensed. At step 507, the control register selection controller 160 determines DMA transfer of data of a predetermined amount by the DMA transfer data counter 140, and goes to step 513 if the predetermined amount of data is transferred, or to step 509 if the predetermined amount of data is not transferred. At step 509, the control register selection controller 160 checks if a destination address of currently DMA transferred data is the same as a predetermined specific address through the data address detector 130, and goes step 513 if the destination address is the same as the predetermined specific address, or goes to step 511 if the destination address is not the same as the predetermined specific address. The control register selection controller 160 checks if a change request signal is input from the main controller 210 in step 511, and goes to step 513 if the change request signal is input, or goes back to step 503 if the change request signal is not input to repeat steps 503 through 513.

Once the change request signals are input from the even/odd detector 120, the data address detector 130, the DMA transfer data counter 140, and the DMA timer 150 that operate according to an operation control value that is predetermined by the main controller 210, the control register selection controller 160 outputs a control register change signal to the control register selector 170 and determines a control register change point, and the control register selector 170 selects a corresponding control register at the determined control register change point.

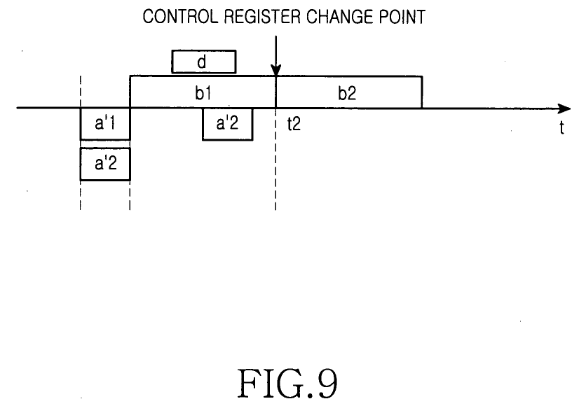

FIG. 9 is a timing diagram of DMA data transfer according to an embodiment of the present invention. In FIG. 9, a′1 and a′2 represent control register setting periods, b1 and b2 represent data transfer periods, and t2 represents a control register change point. During the control register setting period a′1, the main controller 210 stores a control register value related to data to be transferred during the data transfer period b1 in a control register. The main controller 210 may store a value of a control register relating to data to be transferred during the data transfer period b2 in the control register during the control register setting period a′2 at the same time with an operation during the control register setting period a′ 1 or the data transfer period b1. Since a value of a control register that is referred to during the data transfer period b1 is not changed but a value of another control register is changed, such an operation does not affect data transfer. In addition, since setting of a value of a control register to be referred to during the data transfer period b2 is performed by selection of a corresponding control register performed by the control register selector 170 at the start of the data transfer period b2, an accurate time point can be achieved. Moreover, the control register selection module 110 searches for a corresponding control register according to a predetermined operation control value during the data transfer period b1, i.e., a period d, and it is possible to reduce a load on the main controller 210 resulting from a DMA operation.

The invention has been shown and described with reference to a certain preferred embodiment thereof, but various changes in form and details may be made therein without departing from the spirit and scope of the invention. For example, according to an embodiment of the present invention, the control register selection controller 160 independently recognizes change request signals output from the even/odd detector 120, the data address detector 130, the DMA transfer data counter 140, and the DMA timer 150 according to the predetermined change point criterion information and changes a control register into another. However, according to another embodiment of the present invention, the control register selection controller 160 may combine the change request signals and determine a change point. For example, the control register selector 160 may combine the change request signals input from the DMA timer 150 and the even/odd detector 120 and change a control register into another. Thus, when setting an operation control value of the DMA controller 100, the main controller 210 transfers the change point criterion information and combined change point criterion information to the control register selection module 110. The combined change point criterion information is information indicating an actual control register change point satisfies a plurality of change point criteria. The combined change point criterion information includes the type of the plurality of change point criteria to be satisfied and an order the plurality of change point criteria is satisfied. In the above embodiment, the combined change point criterion information indicates a time point when a destination address of data that is currently DMA transferred has an event value after DMA data transfer is performed at predetermined time intervals. The type of the plurality of change point criteria includes a DMA data transfer duration time and an even or odd value of the destination address of data that is currently DMA transferred.

The control register selection module 110 stores the combined change point criterion information in the control register selection controller 160. The control register selection controller 160 outputs the control register change signal to the control register selection controller 170 once DMA data transfer starts and the input of all the change request signals corresponding to the plurality of change point criteria included in the combined change point criterion information is sensed. According to the embodiment of the present invention, after sensing the input of the change request signal from the DMA timer 150 and memorizing the input change request signal, the control register selection controller 160 outputs the control register change signal to the control register selector 170 once the change request signal is input from the even/odd detector 120.

As described above, according to the present invention, through a plurality of control registers and a control register selection module for sequentially selecting one of the plurality of control registers according to a predetermined change point and a previously stored control register change order list during DMA data transfer, DMA data transfer is controlled according to a value of the selected control register, thereby setting a value of a control register at an appropriate time point, reducing a load on a main controller for setting a value of a new control register, and improving the performance of the entire system.

While the invention has been shown and described with reference to certain preferred embodiments thereof, it will be understood by those skilled in the art that various changes in form and details may be made therein without departing from the spirit and scope of the invention.

What is claimed is:

1. An apparatus for controlling a direct memory access (DMA), the apparatus comprising:
a plurality of control registers; and
a control register selection module for sequentially selecting one of the plurality of control registers according to a predetermined change point and a previously stored control register change order list during DMA data transfer to control DMA data transfer according to a value of the selected control register.

2. An apparatus for controlling a direct memory access (DMA), the apparatus comprising:
a plurality of control registers;
a control register selection controller for outputting number information of a next control register according to a previously stored control register change order list and outputting a control register change signal if predetermined conditions for determining a change point are satisfied; and
a control register selector for selecting a control register corresponding to the number information of the next control register among the plurality of control registers once the control register change signal is input.

3. The apparatus of claim 2, wherein the control register selection controller outputs the control register change signal if a destination address of data that is currently DMA transferred is the same as a predetermined address.

4. The apparatus of claim 2, wherein the control register selection controller outputs the control register change signal according to an even/odd value of a destination address of data that is currently DMA transferred.

5. The apparatus of claim 2, wherein the control register selection controller outputs the control register change signal if data is DMA transferred for a predetermined time.

6. The apparatus of claim 2, wherein the control register selection controller outputs the control register change signal if a predetermined amount of data is DMA transferred.

7. The apparatus of claim 2, wherein the control register selection controller outputs the control register change signal once a control register change request is directly input from a main controller.

8. The apparatus of claim 2, wherein the control register selection controller outputs the control register change signal if predetermined conditions for determining a plurality of change points are satisfied.

9. A method for controlling a direct memory access (DMA), the method comprising the steps of:
setting a plurality of control registers;
sequentially selecting one of the plurality of control registers according to a previously stored control register change order list if predetermined conditions for determining a change point are satisfied; and
controlling DMA data transfer according to a value of the selected control register.

10. The method of claim 9, wherein the predetermined conditions for determining a change point include information about whether a destination address of data that is currently DMA transferred is the same as a predetermined address.

11. The method of claim 9, wherein the predetermined conditions for determining a change point include an even/odd value of a destination address of data that is currently DMA transferred.

12. The method of claim 9, wherein the predetermined conditions for determining a change point include information about whether data is DMA transferred for a predetermined time.

13. The method of claim 9, wherein the predetermined conditions for determining a change point include information about whether a predetermined amount of data is DMA transferred.

14. The method of claim 9, wherein the predetermined conditions for determining a change point include information about whether a control register change request is input from a main controller.

15. The method of claim 9, wherein the predetermined conditions for determining a change point include information about whether predetermined conditions for determining a plurality of change points are all satisfied.
